(19) United States
(12) Patent Application Publication
(10) Pub. No.: US 2026/0199854 A1
(43) Pub. Date: Jul. 16, 2026

(54) PLANT FOR NEBULISING LIQUID AND POWDER PRODUCTS

(71) Applicant: Evans Soul Leader S.R.L., Vazzola, Treviso (IT)

(72) Inventor: Luciano SIMONATO, Vazzola (IT)

(73) Assignee: Evans Soul Leader S.R.L., Vazzola, Treviso (IT)

(21) Appl. No.: 19/138,199

(22) PCT Filed: Dec. 6, 2023
(86) PCT No.: PCT/IT2023/050272

§ 371 Date: Jun. 12, 2025

(30) Foreign Application Priority Data
Dec. 15, 2022 (IT) 102022000025734

(51) Int. Cl. B01F 35/22; B01F 23/213; B01F 23/30; B01F 23/70; B01F 35/21; B01F 35/221; B01F 35/90; B01F 35/92

(52) U.S. Cl. CPC B01F 35/2209; B01F 23/2132; B01F 23/32; B01F 23/708; B01F 35/2111; B01F 35/2115; B01F 35/2213; B01F 35/2215; B01F 35/92; B01F 2035/99

(57) ABSTRACT

A plant (100) for nebulising liquid and/or powder products, by means of a vector fluid, such as compressed air or nitrogen, comprising an inlet (1), an outlet (2), a pipe (24) connected to the outlet (2) for connecting the plant (100) to means (25) for applying the liquid and/or powder products to an article, and a treatment circuit (50) of the vector fluid, interposed between the inlet (1) and the outlet (2). The treatment circuit (50) of the vector fluid comprises a pipe (5) wherein a pressure regulator (21), a power generation system (19), a filtering system (18), a heating pipe (40) having a first temperature control probe (41), a deionisation system (22) of the vector fluid, a second temperature control probe (42) and an emergency thermo-resistor (43) are present in cascade.

The present invention relates to a plant for nebulising, by means of a vector fluid such as compressed air or nitrogen, liquids and powders of any type and nature used for surface treatment, whether permanent or not, on any type of manufactured article or workpieces.

The invention falls within the technical field of plants for painting, moulding, die-casting, gluing, etc.

Basically, the invention can be used in all those handicraft and industrial applications where there is a need to transmit a product liquid and/or a powder, of varying density and composition, to an workpiece, in order to create a permanent or temporary protective surface.

For example, the invention can be used in the technical field of industrial and handicraft plants for liquid or powder painting, manual and automatic, with traditional and/or electrostatic system, for the production of wood, plastic, aluminium, ceramic, leather workpieces and in the technical field of gluing materials, such as fabrics, leathers and the like, on rigid supports.

The invention can also be used in the moulding or die-casting of metal or plastic alloys where the application of particular products is required between one moulding and the next to prevent the material to be processed from adhering to the mould, or it can also be used in flocking, tefloning and similar processes.

More particularly, the invention relates to a painting system in which liquid or powder products of any type and nature are nebulised, by means of a vector fluid such as compressed air or nitrogen, and in which spray guns are used, in particular of mixed type, such as air guns, air-mix, electrostatic, rotating cups, etc.

This technology treats the vector fluid that is used for mixing with liquids or powders of any type or nature and also allows one or more guns to be connected in series.

It is well known that the application of liquids and powders of any type and nature is carried out in special booths or installations to create the optimal environment for painting, moulding, die-casting, gluing, flocking, tefloning, enamelling, covering certain drugs, etc.

Such plants provide for the use of a mixture comprising a vector fluid, such as compressed air that is more or less pure and sanitised, and specific liquid and/or powder products.

The spraying of such mixtures is carried out by means of guns, discs or other means adapted and designed for spraying liquid and powder products of any type and nature.

In all cases contemplated by the prior art, after the application of the layer of liquid or powder, the treated workpiece may be dried in a baking oven or a drying booth or in an ambient drying area where polymerisation of the applied product and curing thereof takes place.

Furthermore, in the specific case of the painting process, the surface of the workpiece to be processed usually undergoes a preventive chemical degreasing and passivation treatment and, in general, preparation for the anchoring of the liquid or powder paint.

Currently, painting equipment are usually of the vertical or horizontal type, with manual or automatic guns (reciprocating or anthropomorphic) also of the ‘static’ type.

In automatic vertical type equipment, the workpiece transport system involves a single rail, inside which a bi-planar chain runs, to which support devices are hung that support the workpieces through a hole drilled in one of their ends.

On the other hand, in horizontal type painting equipment, the workpieces are loaded onto the so called ‘pillars’ suspended from balanced supports mounted on a conveyor belt.

Finally, in “static” type painting, the workpieces are manually placed on fixed or rotating supports and, once the painting operation is finished, are manually transferred to the drying zone.

The principle currently in use in industrial and/or handicraft powder or liquid painting is linked, in addition to the traditional method, to the electrostatic attraction that occurs between a paint particle (reduced to powder or nebulised through a vector fluid such as compressed air), which is positively or negatively charged, and the object to be painted, which is electrically grounded.

More in detail, the nebulised paint particles are charged in such a way that the dual effect of spraying and electrostatic charging achieves perfect coverage of the surface to be painted and better paint performance.

The particles can be charged, for example, by using ionised air, by means of the so-called ‘corona process’, or by means of a high-voltage ioniser integrated in the spray gun. The ioniser injects ionised air into a channel through which the paint particles flow, and these paint particles are electrified before they are deposited on the surface of the object to be painted, by means of an electrode, which is placed in the channel near the spray nozzle.

Alternatively, paint particles can be charged inside a gun channel by rubbing them in a spiral motion in contact with the inner walls of the spray gun channel.

In order to electrically ground the workpiece to be painted, the workpiece is suspended from metal supports placed in contact with structures or devices that are also electrically grounded.

Similar processes are used for the application of liquids and powders for other types of processing, such as moulding, die-casting, flocking, tefloning, enamelling, coating of medicines and similar.

In such processes, the ultimate aim is to coat an item with an embellishment, protection or creation of a neutral layer that does not allow the adhesion of foreign materials (mould) so as to have a constant production without wasting product and time for continuous maintenance of the work areas.

However, all conventional liquid and powder spraying systems, according to the prior art, still have significant drawbacks, including:
the considerable use and waste of product
the high operating pressures;
the rapid wear and the necessary and frequent replacement of components;
the high waste of time;
the high running costs;
the high energy and/or fuel consumption.

Another major drawback is the fact that the considerable use of liquid and powder products, of whatever type and nature and in whatever field of use, entails many problems relating to environmental pollution.

In particular, these problems are related to the polluting impact of liquids and powders (more or less harmful chemical compounds) that are dispersed into the environment and working areas where workers are constantly present.

The aim of the present invention is therefore to provide a plant for the nebulisation, by means of a vector fluid, of liquids and powders, which can be used in any field and capable of employing, in particular, spray guns, e.g. air-mix, capable of resolving to a large extent the aforementioned inconveniences and criticisms of the prior art.

The aim of the present invention is, therefore, to realise a plant for nebulising liquids and powders, in particular by means of spray guns, which makes it possible to considerably reduce the amount of product used.

Another aim of the present invention is to provide a plant for nebulising liquids and powders, which makes it possible to reduce processing times and, in particular, application times, drying times and maintenance times with respect to the prior art.

A further aim of the present invention is to provide a liquid and powder nebulisation plant, which makes it possible to reduce environmental pollution and product waste, while at the same time guaranteeing an excellent final quality of the workpiece.

Another aim of the present invention is to provide a liquid and powder nebulisation plant, which is efficient and reliable and which can be used both in handicrafts and in industries.

A further aim of the present invention is to provide a liquid and powder nebulisation plant which can be used with air-mix, air-mix, mixed, rotary cup, hand-held, anthropomorphic, reciprocating, etc. guns.

It is also an aim of the present invention to realise a liquid and powder nebulisation plant, which employs a vector fluid, such as compressed air or nitrogen, at a lower pressure than the prior art, and which allows for greater cleanliness of filters and working environments.

A further aim of the present invention is to realise a liquid and powder nebulisation plant, which allows a considerable saving of processing hours for the final production of a product, compared to traditional plants.

Another aim of the present invention is to realise a liquid and powder nebulisation plant, in particular of the spray type, which is capable of reducing all volatile and solid pollutants produced during product application operations.

A further aim of the present invention is to realise a liquid and powder nebulisation plant, which can significantly decrease the use of electrical energy and compared to the prior art.

A further aim of the present invention is to realise a liquid and powder nebulisation plant, whereby solvents and other liquids used for diluting the products to be used are drastically reduced.

These and other aims are achieved by a plant for nebulisation of liquids and powders according to the attached independent claim.

Further detailed technical features are set out in the attached dependent claims.

The present invention will now be described, by way of example but not limitation, according to some preferred embodiments thereof, and with the aid of the attached figures, wherein:

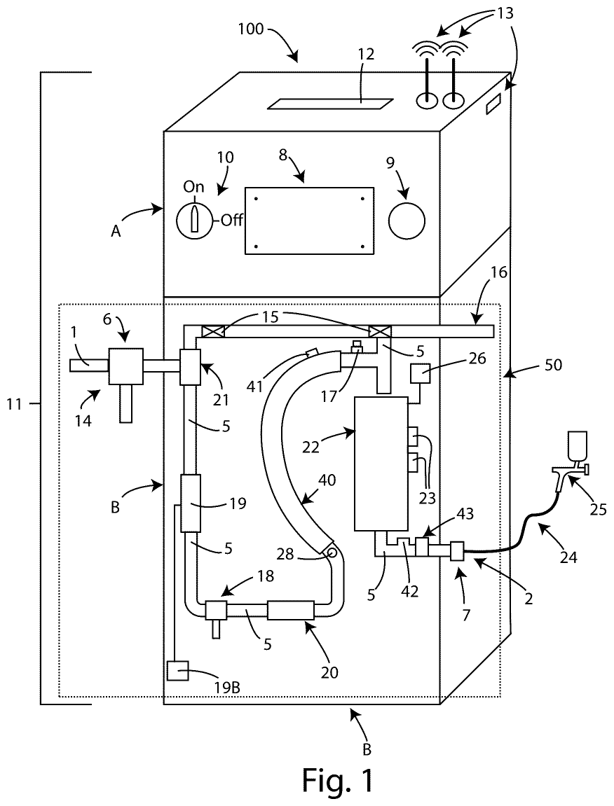

FIG. 1 is a schematic view of a first embodiment of a plant for nebulising liquid and powder products of any kind and nature according to the invention;

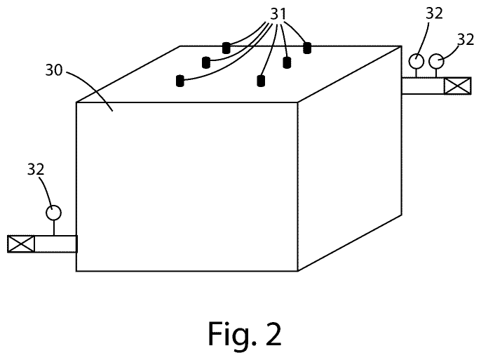

FIG. 2 is a schematic view of a heating device employed according to a further embodiment of the plant according to the invention.

Referring to the aforementioned figures, it is shown a preferred embodiment of a plant for nebulising liquids and powders of any type and nature according to the invention.

Referring to the aforementioned figures, the plant subject matter of the invention is generically indicated by the numerical reference 100 and uses a vector fluid, such as compressed air or nitrogen, to nebulise liquids and powders, in particular by means of spray guns; in a first embodiment thereof, the plant 100 comprises a first device A and a second device B capable of containing all the elements and operating components.

Advantageously, the series connection of the elements of the plant 100 allows the compressed air or nitrogen, which act as the vector fluid, to enter into the plant 100, via a first pipe or inlet 1, which can be of a different diameter depending on the embodiment, and to exit from the same plant 100 via a second pipe or outlet 2, which can be of a different diameter depending on the embodiment, after having undergone the processes that lead to the modification of the characteristics of the vector fluid itself.

Between the inlet 1 of the vector fluid and the outlet 2 of the same vector fluid is present a treatment circuit 50, placed between a connector 6 of the inlet vector fluid and a control connector 7 of the outlet vector fluid.

Downstream of the control connector 7 of the outlet vector fluid is present a pipe 24 for connecting the plant 100 to one or more spray guns 25 or otherwise general means for applying the liquid and/or powder products to certain workpieces.

Advantageously, the spray guns 25 may be of different types, such as air-mix, electrostatic or corona guns, etc.

In more detail, such spray guns 25 may comprise two separate pipelines and, in particular, a first pipeline carrying the vector fluid (e.g., compressed air or nitrogen) and a second pipeline carrying the liquid or powder, so that the vector fluid and the liquid or powder product are emitted simultaneously during the treatment operations.

In other embodiments, the plant 100 comprises a single cabinet or enclosure containing both the first device A and the second device B.

Advantageously, the first device A comprises one or more display and control elements 8 for controlling the elements and components of the plant 100.

By way of example, such display and control elements 8 may be:
a screen, for example LCD, also touchscreen;
a removable tablet for remote control via a Wi-Fi or synoptic connection;
a push-button panel;
a lamp or other signalling device capable of changing colour according to the working status of the plant 100;
an acoustic signalling device for potential faults and emergencies.

In particular, advantageously, any display and control element 8 or any other type of control set known and described in the state of the art can be used to control the functions of the plant 100.

Advantageously, the first device A is provided with an emergency button 9 and a switch or on/off switch or device 10.

More in detail, the emergency button 9 allows the operation of the plant 100 to be interrupted in the event of faults or emergencies, while the on/off switch or device 10 allows the plant 100 to be switched on and off before and after operation has been carried out.

Still advantageously, inside the first device A is installed an electronic circuit and/or a PLC (not shown) for managing the plant 100 itself.

Still advantageously, in the higher part of the first device A are installed:
a visual and acoustic indicator 12 indicating the correct functioning and working phases of the plant 100 and which can change colour according to the working status of the plant 100;
one or more Wi-Fi and/or wireless antennas and/or Ethernet ports 13 for distant or remote control and/or Internet connection.

In a preferred embodiment of the present invention, the vector fluid treatment circuit 50 is present in the second device B.

Advantageously, the aforementioned vector fluid treatment circuit 50 comprises:
a pressure reducer 14, for example from 0 to 12 bar, with or without filter, placed downstream of the inlet 1;
a main pipe 5, of any diameter, into which, under normal operating conditions, is sent the vector fluid drawn at inlet 1;
a potential emergency pipe 16 used in emergency or maintenance conditions, which includes a plurality of by-pass valves 15 for managing the flow of the vector fluid in emergency or maintenance conditions.

In particular, the by-pass valves 15 have the task of directing the flow of the vector fluid into the main pipe 5 when the plant 100 is in normal operating conditions, while they are capable of diverting the flow of the vector fluid into the emergency pipe 16 when the main pipe 5 is damaged or in need of some type of maintenance and/or control.

Advantageously, the main pipe 5 of the vector fluid treatment circuit 50 presents one or more of the following additional components placed between the inlet 1 and the outlet 2, among which:
a digital and automatic pressure regulator 21 of the vector fluid flow, in order to be able to regulate the pressure (also remotely) of the vector fluid so as to achieve optimal nebulisation and mixing of the product to be applied to the workpiece;
an power generation system 19, such as a turbine, complete with a storage battery 19B;
a filtering system 18 for cleaning the inlet vector fluid;
a digital probe 20, such as a flow switch or anemometer, adjustable and in communication with the display and control system 8;
a non-return valve 28;
a heating medium or pipe 40;
a deionisation system 22 of the vector fluid;
a digital probe 20, such as a flow switch or anemometer, adjustable and in communication with the display and control system 8;
a safety valve 17, pre-calibrated according to the maximum predetermined value of pressure of the vector fluid to be obtained.

In particular, the filtering system 18 has the task of preventing the introduction of impurities or dirt into the main pipe 5, the digital probe 20 and the deionisation system 22.

Advantageously, the power generation system 19 allows the flow of the vector fluid to be transformed into energy, which can also be used to power the plant 100.

In a preferred embodiment, the power generation system 19 is a turbine set in motion by the passage of the vector fluid and capable of producing energy for total or partial powering of the plant.

More in detail, the power generation system 19 allows the plant 100 to consume less energy than known plants, also making it autonomous in the event of malfunctions or interruptions of the power grid.

Furthermore, in the event that there is more energy production than that used to operate the system, it is possible to store the excess energy in the storage battery 19B for a later use when required.

Advantageously, the connection and linkage between the digital probe 20 and the display and control system 8 allows the amount of vector fluid consumed by the plant 100 to be monitored and memorised.

Even more advantageously, during the work cycle, the digital probe 20 acts as a start/stop switch allowing the operation of the devices A and B only if there is a flow of vector fluid moving in the main pipe 5. Otherwise, if the digital probe 20 detects that a stationary vector fluid is present within the plant 100, the plant 100 remains in stand-by mode using energy only to keep the controls switched on.

In a preferred embodiment, the deionization system 22 comprises or is connected to one or more transformers 26, of the type with variable power and/or adjustable by the display and control system 8 and is connected a plurality of needles 23, independent and easily interchangeable, connected to each other so as to create a magnetic field capable of extracting the static charges present in the vector fluid passing through the main pipe 5 and circulating in the deionization system 22.

In particular, the needles 23 also make it possible to neutralise any dirt present in the circulating vector fluid and, in particular, at the outlet of the deionisation system 22.

Advantageously, the deionisation system 22 also presents one or more couplings for connecting one or more deionising pipes with heating elements and temperature control probes, e.g. of the PT100 or PT1000 type.

Operatively, after the passage in the digital probe 20, the vector fluid passes through a heating pipe 40, which heats the same vector fluid to be fed into the deionisation system 22.

After passing through the deionisation system 22, the vector fluid flows through the control connector 7, passes through the outlet pipe 2 and is fed into the pipe 24, which connects the plant 100 to the spray guns 25 (or other means of applying the liquid or powder products).

Advantageously, the heating pipe 40 comprises a flexible heating tube positioned between the digital probe 20 and the deionisation system 22.

Such positioning allows optimisation of the vector fluid, which is first filtered and then deionised; thus, better heating performance and lower energy consumption are achieved.

In a preferred embodiment, the heating pipe 40 includes a heating tube comprising an external electric resistance and a control probe 41, which senses the temperature of the vector fluid in the heating pipe 40.

More particularly, such heating pipe 40 is of a larger diameter and weight than the connecting pipe 24.

More in detail, the detection of the temperature of the vector fluid in the heating pipe 40 occurs during the heating phase and the temperature can be adjusted as desired. In addition, a second control probe 42 is positioned at the outlet of the vector fluid from the deionisation system 22, on the main pipe 5.

Advantageously, both control probes 41 and 42 can be adjusted at will according to working requirements, by means of the controls on the display and control system 8 or remotely.

By way of example, these control probes 41 and 42 can be of the PT100 or PT1000 type.

Advantageously, the heating pipe 40 may comprise a silicon resistor inside it and may be covered with heat-insulating material.

In a preferred form of the present invention, the control probe 41 is placed inside the heating pipe 40 and may be coupled with the silicon resistor.

Advantageously, the coupling of the silicon resistor with the probe 41 allows the heating of the vector fluid to be set, even remotely, up to a maximum operating temperature of about 70/80° C., variable according to the requirements of the user.

More in particular, the control probe 41 allows controlling the temperature inside the heating pipe 40, while the control probe 42 allows controlling the temperature of the vector fluid at the outlet of the heating pipe 40.

As a further safety feature, a pre-calibrated emergency thermo-resistor 43, for example a thermo-fuse, is positioned in the main pipe 5, positioned after the probe 42 and before the outlet 2, which intervenes in the event of simultaneous failure of the probes 41 and 42.

Advantageously, the heating pipe 40 can be configured to realise a connection to two or more deionisation systems 22, which serve several spray guns 25 simultaneously.

In a further embodiment, when a larger volume of vector fluid is required to be heated, the heating pipe 40 may be replaced or coupled with an additional heating device 30, the further heating device 30 allows to control the temperature of a significantly larger volume of vector fluid and further allows the use of a plurality of spray guns 25.

In particular, the heating device 30 comprises within it a plurality of electrical resistors 31 and a plurality of probes 32 connected to the display and control system 8, so that the temperature of the vector fluid inside the heating device 30 itself can be changed at will.

Advantageously, the heating device 30 does not necessarily have to be installed internally or consecutively to the plant 100 but may also be positioned externally, detached and at a distance from the same plant 100.

Preferably, the probes 32 are arranged one at the inlet of the heating device 30 and two at the outlet of the same heating device 30.

The operation of the plant 100 for nebulising liquid and powder products of any type and nature, according to the present invention, is substantially as follows.

Initially, the plant 100 is manually switched on by means of the on/off switch or device 10; in this state, only the display and control system 8 is switched on, while the visual and acoustic indicator 12 is on stand-by and all the main functions of plant 100 are inactive and do not consume energy.

Advantageously, plant 100 can also be switched on remotely, for example from a fixed location outside the working area, but located in the same establishment, or in a different establishment.

When the vector fluid is requested for work operations, the digital probe 20 detects the flow of the vector fluid and sends a signal to the display and control system 8, which operates the pressure regulator 21, the needles 23, the deionisation system 22, the heating pipe 40 and the probes 41 and 42.

Advantageously, through the display and control system 8, the user can set a temperature value of the operating vector fluid, a spray pressure and a deionisation power.

Advantageously, through the Wi-Fi and/or wireless antennas and/or Ethernet ports, it is possible to control and set the plant 100 remotely.

Once the parameters have been set by the user, the heating pipe 40 heats the vector fluid until the set value is reached and controlled by the probes 41, 42, while the deionisation system 22 eliminates static charges in the vector fluid.

Advantageously, the heating pipe 40 placed in front of the deionisation system 22 significantly increases the general performance of the plant 100 bringing clear benefits in the general use of the plant.

Advantageously, with respect to known techniques, the connection of devices A and B allows precise control of the state of the treated vector fluid flow and allows, through the possibility of increasing the heating and deionising power, the availability of serving several guns 25 simultaneously, making them independent of each other, thanks to the regulation of the operating temperature.

Advantageously, these guns 25 are connected in series so that they are all connected to plant 100 to exploit its advantages.

The plant 100 according to the present invention therefore allows a considerable saving of liquid and/or powdered product for the dilution used during the work cycle, consequently obtaining a lower environmental impact, a healthier and saner workplace, an increase in the duration of the filters of the suction systems, a reduction in product residues (sludge) to be disposed of as special waste, as well as a considerable saving of electrical energy for operation.

This energy saving is due to the use of the power generation system 19, in particular equipped with the storage battery 19B, present in the main pipe 5, which allows the production of energy for the operation of the plant 100 without the need to acquire energy from external sources or from the power grid and at the same time to store it in reserve for use in case of emergency.

The power generation system 19, complete with the storage battery 19B, thus allows for significant savings in electrical energy for the operation of the devices A and B, as well as significant savings in terms of working time for the treatment of the workpieces and for the maintenance of the plants.

Compared to the prior art, the present invention also allows the decrease in the use of liquid and/or powdered products, also allowing the decrease in the use of diluent products in any environment, whether atmospheric or indoor.

In particular, the digital probe 20 saves energy by maximising downtime without the need for manual intervention to switch the plant 100 on and off.

Furthermore, by measuring the consumption of the vector fluid, the plant 100 precisely establishes maintenance times and allows the user to read, even remotely, the actual consumption of vector fluid used for each treatment performed.

Advantageously, then, the automatic pressure regulator 21 allows the vector fluid to be used with extreme precision, giving the possibility of modifying and controlling, even remotely, the pressure used, with any type of liquid and powder product and for any workpiece, as well as in any environmental state, bringing maximum savings in product, vector fluid, time for cleaning the working environment, speed of application and reduction of harmful emissions.

In addition, the plant 100 also allows for savings of filtering material in the working environments (open booths, clean rooms, presses, press ovens, catenaries, moulding areas, moulding presses, suction benches for gluing, etc.), the significant reduction of atmospheric emissions of fine dust and harmful gases, and the creation of healthier working environments compared to traditional application plant of the prior art.

With respect to the prior art, it is clear that the combination of these technologies and their system of application give this invention the clear characteristic of uniqueness.

From the above description, the characteristics of the plant for nebulising liquids and/or powders of any type and nature, which is the subject matter of the present invention, are clear, as are its advantages.

Lastly, it is clear that numerous other variations can be made to the plant in question, without thereby departing from the principles of novelty inherent in the inventive idea, just as it is clear that, in the practical implementation of the invention, the materials, shapes and sizes of the details illustrated can be any according to requirements and the same can be replaced with equivalent ones.

Where the features and techniques mentioned in any of the claims are followed by reference marks, those reference marks have been included for the sole purpose of increasing the intelligibility of the claims and, accordingly, those reference marks have no limiting effect on the interpretation of each element identified by way of example by those reference marks.

1. A plant (100) for nebulising liquid and/or powder products by means of a vector fluid, such as compressed air or nitrogen, having a cabinet or enclosure (11), comprising:
a first device (A) comprising one or more display and control elements (8) for controlling and operating the elements and components of said plant (100),
a second device (B) further comprising a treatment circuit (50) of said vector fluid, wherein said treatment circuit (50) of said vector fluid comprises in turn a first pipe (1) for the inlet of said vector fluid into said plant (100), said first pipe (1) being provided with an inlet connector (6) and a pressure reducer (14), and a second pipe (2) for the outlet of said vector fluid from said plant (100), wherein said second pipe (2) for the outlet of the vector fluid from the plant (100) is connected to a third pipe (24) for the connection to one or more guns (25) or means for nebulisation and application of said liquid and/or powder products,
wherein the fact that said first pipe (1) for the inlet of the vector fluid into the plant (100) is connected to a fourth pipe (5) in which are present, in cascade, the following elements:
a pressure regulator (21) for regulating the pressure of the vector fluid;
an power generation system (19) with a storage battery (19B), installed immediately downstream of said pressure regulator (21), which converts the vector fluid in transit within said fourth pipe (5) into energy usable for the partial or total power supply of said plant (100),
a filtering system (18) for the cleaning of the vector fluid, placed immediately downstream of said power generation system (19),
at least one heating pipe (40), placed downstream of said filtering system (18), having inside it a first temperature control probe (41),
a deionisation system (22) of the vector fluid, placed downstream of said heating pipe (40),
a second temperature control probe (42), placed at the outlet of said deionization system (22), configured to implement a temperature control of the vector fluid exiting said deionization system (22) and connected to a control connector (7), said control connector (7) being suitable to connect said fourth pipe (5) at the outlet of said deionization system (22) to said second pipe (2) at the outlet of said plant (100),
a digital probe (20) and a non-return valve (28), placed between said filtering system (18) and said heating pipe (40), said digital probe (20) is connected to said one or more display and control elements (8) and is capable of detecting the flow of the vector fluid and capable of sending a signal to said one or more display and control elements (8) for operating and controlling said pressure regulator (21), of said heating pipe (40), of said first and second temperature control probes (41, 42) and of said deionization system (22), said digital probe (20) being configured to function as a start/stop switch allowing operation of the plant (100) only if a flow of the vector fluid is present in said fourth pipe (5).

2. Nebulization plant (100) according to claim 1, wherein, downstream of said second temperature control probe (42), is installed a pre-calibrated emergency thermo-resistor (43), which intervenes in the event of simultaneous failure of said first and second temperature control probes (41, 42).

3. Nebulization plant (100) according to claim 1, wherein the fact that between said heating pipe (40) and said deionization system (22) is present a safety valve (17) pre-calibrated on a maximum predetermined value of pressure of the vector fluid present in the fourth pipe (5).

4. Nebulization plant (100) according to claim 1, wherein said pressure regulator (21) is connected to an emergency pipe (16) with by-pass valves (15) for diverting the flow of said vector fluid from said fourth pipe (5) into said emergency pipe (16) in case of emergency conditions or in case of maintenance of the fourth pipe (5).

5. Nebulization plant (100) according to claim 1, wherein said heating pipe (40) comprises a flexible heating tube with an external electric resistance.

6. Nebulization plant (100) according to claim 1, wherein said heating pipe (40) is coupled to a further heating device (30) comprising a plurality of electrical resistors (31) and a plurality of probes (32) connect to said one or more display and control elements (8).

7. Nebulization plant (100) according to claim 1, wherein said first device (A) of said plant (100) comprises a visual and acoustic indicator (12) to indicate the correct functioning of the plant (100) and one or more Wi-Fi and/or wireless antennas and/or Ethernet ports (13) for remote control of the plant (100)

8. Nebulization plant (100) according to claim 1, wherein said deionization system (22) comprises or is connected to at least one variable power transformer (26) and is connected to a plurality of independent needles (23) for the creation of a magnetic field suitable for extracting the static charges and neutralizing the dirt present in the vector fluid in transit in the fourth pipe (5) and in the deionization system (22).

9. Nebulization plant (100) according to claim 1, wherein said plant (100) comprises an electronic circuit and/or PLC for the overall management of said plant (100).
